(19) United States
(12) Patent Application Publication
(10) Pub. No.: US 2016/0365106 A1
(43) Pub. Date: Dec. 15, 2016

(54) ADJUSTING METHOD, MAGNETIC DISK DEVICE, AND MANUFACTURING METHOD OF MAGNETIC DISK DEVICE

(71) Applicant: Kabushiki Kaisha Toshiba, Tokyo (JP)

(72) Inventor: Shuuichi Kojima, Tokyo (JP)

(21) Appl. No.: 15/014,751

(22) Filed: Feb. 3, 2016

Related U.S. Application Data
(60) Provisional application No. 62/175,745, filed on Jun. 15, 2015.

(51) Int. Cl. G11B 5/60

(52) U.S. Cl. CPC G11B 5/607

(57) ABSTRACT

According to one embodiment, an adjustment method is applied to a magnetic disk device includes a disk, and a head including a heater and configured to protrude to the disk based on amount of heat the heater varies. The method includes calculating a first adjust amount by subtracting a difference, for spacing the head from the disk, from a first control amount applied to the heater when the head contacts a first area, calculating a second adjust amount by subtracting the difference from a second control amount applied to the heater when the head contacts a second area, and adjusting a time when the second adjust amount is applied to the heater, based on a result of comparison between the first and second control amounts.

### CROSS-REFERENCE TO RELATED APPLICATIONS

This application claims the benefit of U.S. Provisional Application No. 62/175,745, filed Jun. 15, 2015, the entire contents of which are incorporated herein by reference.

### FIELD

Embodiments described herein relate generally to an adjustment method, a magnetic disk device, and a method of manufacturing the magnetic disk device.

### BACKGROUND

In control of a hard disk drive (HDD), touchdown measurement is known as one process for controlling the gap (flying height of a head) between a head and a disk. The touchdown measurement is a method in which electric power is applied to a heating element (heater) of the head to expand the head and protrude a portion thereof to the disk, thereby measuring an applied power (control amount) detected when the head contacts the disk.

In general, in the touchdown measurement, a probable value is computed as a true value, based on a measurement value acquired after one or more trials. If excessive electric power with respect to the true value is applied to the heater of the head, the head may contact the disk. Contact of the head and the disk may be a factor of head damage or degradation of the reliability of the device.

### BRIEF DESCRIPTION OF THE DRAWINGS

FIG. 1 is a block diagram showing a configuration of a magnetic disk device according to a first embodiment.

FIG. 2A is a schematic view showing a state of a head before expansion in the first embodiment.

FIG. 2B is a schematic view showing a state of the head after expansion in the first embodiment.

FIG. 3 is a conceptual diagram for explaining a method of adjusting a control amount based on a measurement result.

FIG. 4A is a diagram showing an example of a protrusion distribution obtained when a particular control amount is applied over one track circumference, and an example of an ideal protrusion distribution in DFH control.

FIG. 4B is a diagram showing an example of a protrusion distribution obtained when the control amount is adjusted in each of areas into which one track is divided, and the example of an ideal protrusion distribution in DFH control.

FIG. 5 is a diagram showing examples of detection criteria.

FIG. 6A is a diagram for roughly explaining the relationship between area and protrusion obtained when touchdown measurement is executed area by area.

FIG. 6B is a diagram for roughly explaining the relationship between the area and the protrusion obtained when the control amount is adjusted earlier than in the case of FIG. 6A.

FIG. 7A is a diagram showing an example of a protrusion distribution obtained by actual measurement in the touchdown measurement shown in FIG. 6A.

FIG. 7B is a diagram showing an example of a protrusion distribution obtained by actual measurement in the touchdown measurement shown in FIG. 6B.

FIG. 8A is a diagram for roughly explaining a processing procedure example of the touchdown measurement of the first embodiment.

FIG. 8B is a diagram for roughly explaining another processing procedure example of the touchdown measurement of the first embodiment.

FIG. 8C is a diagram for roughly explaining yet another processing procedure example of the touchdown measurement of the first embodiment.

FIG. 8D is a diagram for roughly explaining a further processing procedure example of the touchdown measurement of the first embodiment.

FIG. 9 is a flowchart showing the touchdown measurement of the first embodiment.

FIG. 10 is a flowchart showing part of a process of manufacturing the magnetic disk device of the first embodiment.

FIG. 11 is a flowchart showing a method of adjusting a control amount during a read/write operation.

FIG. 12 is a view for explaining concept of classification of a disk according to a modification embodiment.

FIG. 13 is a view for explaining an interpolation method example of the control amount between zones in the modification embodiment.

FIG. 14 is a flowchart example showing touchdown measurement executed zone by zone in the modification embodiment.

FIG. 15A is a diagram for roughly explaining the relationship between area and protrusion obtained when touchdown measurement is executed area by area in a second embodiment.

FIG. 15B is a diagram for roughly explaining relationship between the area and the protrusion obtained when the area is extended in FIG. 15A.

FIG. 16 is a flowchart showing a touchdown measurement method according to the second embodiment.

### DETAILED DESCRIPTION

In general, according to one embodiment, there is provided an adjustment method applied to read and write operations of a magnetic disk device comprising a disk, and a head including a heater and configured to protrude to the disk based on amount of heat of the heater varies in accordance with a control amount applied thereto, the adjustment method comprising: calculating a first adjust amount by subtracting a difference, for spacing the head from the disk, from a first control amount applied to the heater when the head contacts a first area included in a plurality of areas into which a storage area of the disk is circumferentially divided; calculating a second adjust amount by subtracting the difference from a second control amount applied to the heater when the head contacts a second area included in the plurality of areas, the second area being adjacent to the first area along a circumference of the disk; and adjusting a time when the second adjust amount is applied to the heater, based on a result of comparison between the first and second control amounts.

Embodiments will now be described with reference to the accompanying drawings.

### First Embodiment

In a first embodiment, a description will be given of a touchdown measurement method as an example of a technique of evaluating flying height of a magnetic head (head) in dynamic flying height (DFH) control.

In the DFH control, thermal expansion of part of a head is controlled by controlling electric power applied to a heating element (heater) provided in the head. In the DFH control, by controlling the thermal expansion, flying height (flying amount) of the head with respect to a disk is controlled. The electric power applied to the heater is proportional to a DFH control amount (control amount), and changes in accordance with the control amount. The control amount is represented by a digital-to-analog converter value (DAC value).

Touchdown measurement is a method of measuring a control amount when the head contacts the disk. As an example, a method is pointed out in which the head is brought into contact with the disk (touchdown), thereby setting, as a reference control amount, a control amount obtained when the contact is detected. When the touchdown is detected, the head and the disk are estimated to contact each other. At this time, the flying height can be minimum. The measured value acquired by the touchdown measurement is used for, for example, control of the flying height of the head. The touchdown measurement is executed during a test process in a manufacturing process of the magnetic disk device, or in the magnetic disk device as a product.

A magnetic disk device 1 will be described as an example to which the touchdown measurement method of the embodiment is applied.

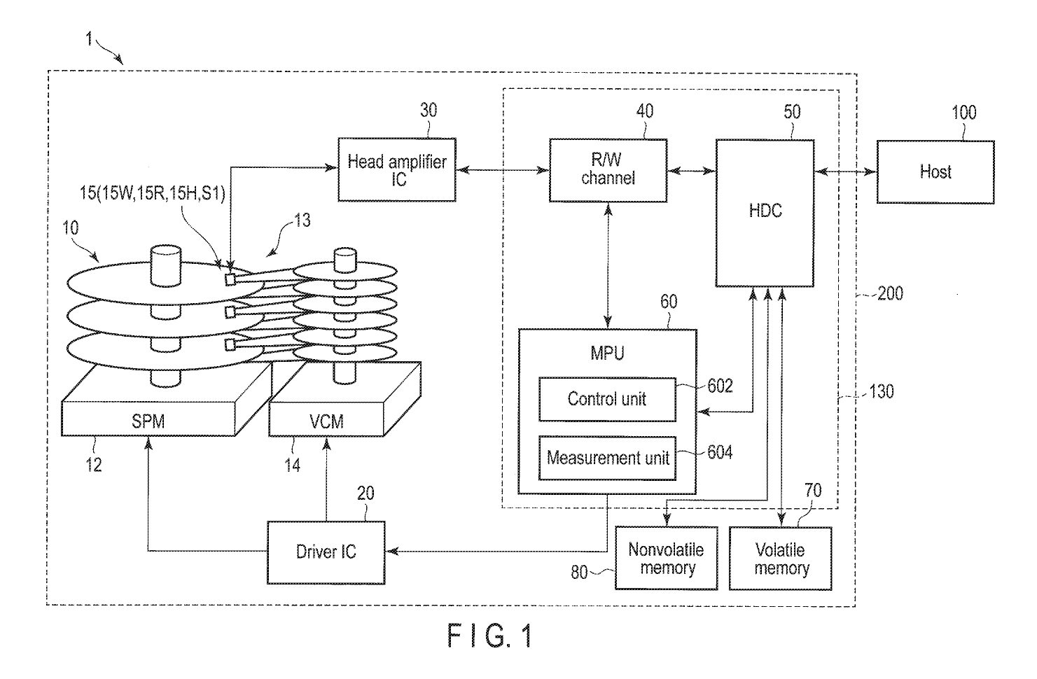

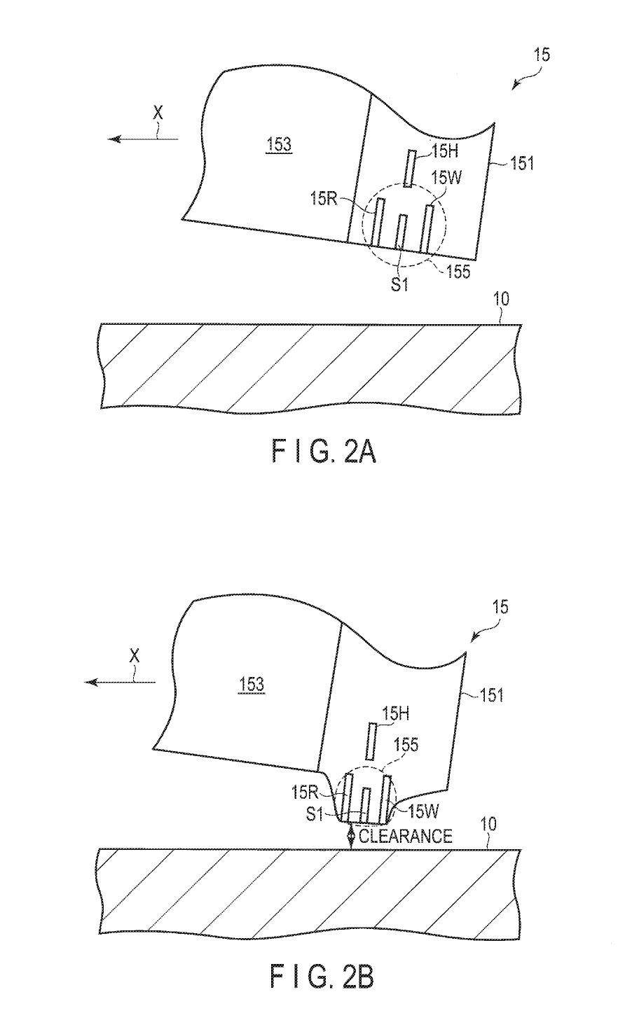

FIG. 1 is a block diagram showing the configuration of the magnetic disk device 1 according to the embodiment. FIGS. 2A and 2B schematically show a head 15 and a disk 10 employed in the embodiment. FIG. 2A schematically shows a state of the head 15 before expansion, and FIG. 2B schematically shows a state of the head 15 after expansion.

The magnetic disk device 1 includes a head disk assembly (HDA), described later, a driver IC 20, a head amplifier integrated circuit (hereinafter, referred to as a head amplifier IC) 30, a volatile memory 70, a nonvolatile memory 80, a system controller 130 formed of a one-chip integrated circuit, and a housing 200 housing these elements. In the magnetic disk device 1, the system controller 130 is connected to driver IC 20, the head amplifier IC30 and the volatile memory 70. Further, the magnetic disk device 1 is connected to a host system (host) 100.

The HDA includes a magnetic disk (hereinafter, referred to simply as the disk) 10, a spindle motor (SPM) 12, an arm 13 with the head 15, and a voice coil motor (VCM) 14. The disk 10 is rotated by the spindle motor 12. The arm 13 and the VCM 14 constitute an actuator. The actuator is driven by the VCM 14 to move the head 15 to a particular position on the disk 10. The embodiment actually employs one or more disks 10 and one or more heads 15.

The head 15 includes a thin film head portion 151 and a slide 153. The head 15 is connected to the head amplifier IC 30.

The thin film head portion (hereinafter, referred to as the head portion) 151 includes a read head 15R, a write head 15W, a heating element (heater) 15H, and a head disk interface (HDI) sensor S1. The read head 15R reads data currently recorded on the disk 10. The write head 15W writes data to the disk 10. In the description below, the read head 15R and the write head 15W are collectively referred to as a read/write element. The heater 15H generates heat when electric power is applied thereto. The head portion 151 may include a plurality of heaters. When the head portion 151 includes a plurality of heaters, the respective heaters may be provided near the read head 15R and the write head 15W.

With reference to FIGS. 2A and 2B, a description will be given of a state in which the head 15 (head portion 151) protrudes. In FIG. 2A and FIG. 2B, the head 15 moves in a direction indicated by arrow X in accordance with the rotation of the disk 10. As shown in FIG. 2A, a state (normal state) where the heater 15H is not heating corresponds to a state where the periphery (hereinafter, referred to as a read/write portion 155) of the read/write element of the head portion 151 does not protrude toward the disk 10. As shown in FIG. 2B, a state where the heater 15H is heating corresponds to a state where the read/write portion 155 is thermally expanded by the heat of the heater 15H and protrude toward the disk 10. When the read/write portion 155 protrudes, the thermally expanded top of the read/write portion 155 serves as the lowest point of the head 15. In the description below, a change from a state where the head 15 does not protrude to a state where the head 15 protrudes will be referred to as a protrusion. The protrusion is substantially proportional to electric power applied to the heater 15H and the control amount. The flying height can be expressed by the gap between the disk 10 and the head 15 (the top of the read/write portion 155).

Therefore, if the control amount is increased to increase the electric power applied to the heater 15H, the protrusion of the head 15 is increased. In contrast, if the control amount is decreased to decrease the electric power applied to the heater 15H, the protrusion of the head 15 is decreased. Namely, the flying height of the head 15 is appropriately controllable by appropriately adjusting the control amount at the time of a read operation and a write operation (read/write operation).

The HDI sensor S1 is provided, for example, in the head portion 151 as the lower portion of the heater 15H near the bottom thereof between the read head 15R and the write head 15W. The HDI sensor S1 is connected to the head amplifier IC. The HDI sensor S1 includes a resistance element. When the head 15 contacts the disk 10, the resistance of the resistance element is changed by fine heat produced by the friction between the disk 10 and the head 15.

Returning to FIG. 1, the driver IC 20 is connected to the SPM 12 and the VCM 14, and controls them.

The head amplifier IC 30 includes a read amplifier and a write amplifier (not shown). The read amplifier amplifies a read signal read by the read head 15R, and transmits it to a R/W channel 40, described later. The write amplifier transmits, to the write head 15W, a write current corresponding to a write signal output from the R/W channel 40. The head amplifier IC 30 functions as an adjustment circuit for applying electric power to the heater 15H and adjusting electric power thereof. The head amplifier IC 30 detects a change in the resistance of the resistor element of the HDI sensor S1.

The volatile memory 70 is a semiconductor memory wherein stored data is lost when power supply is interrupted. The volatile memory 70 stores, for example, data required for processing in each part of the magnetic disk device 1. The volatile memory 70 is, for example, a synchronous dynamic random access memory (SDRAM).

The nonvolatile memory 80 is a semiconductor memory that holds data even when power supply is interrupted. The nonvolatile memory 80 is, for example, a flash read only memory (ROM). The nonvolatile memory 80 is connected to the system controller 130 (for example, an HDC 50).

The system controller 130 (controller) includes the R/W channel 40, the hard disk controller (HDC) 50, and a microprocessor (MPU) 60.

The R/W channel 40 performs signal processing of read and write data. The R/W channel 40 decodes read data extracted from a read signal supplied from the head amplifier IC 30. The R/W channel 40 transmits the decoded read data to the HDC 50 and the MPU 60. The read data includes user data and servo data. The R/W channel 40 subjects write data, supplied from the HDC 50 and the MPU 60, to code modulation, and converts the code-modulated write data into a write signal. The R/W channel 40 transmits the write signal to the head amplifier IC 30.

The HDC 50 controls data transfer between the host 100 and the R/W channel 40, using the volatile memory 70.

The MPU 60 is a main controller connected to each element of the magnetic disk device 1 to control them. The MPU 60 controls the VCM 14 via the driver IC 20, and performs servo control for positioning the head 15. Further, the MPU 60 outputs an instruction signal to the head amplifier IC 30 to thereby control the protrusion and flying height of the head 15.

The MPU 60 includes a control unit 602 and a measurement unit 604. The processing of these parts is executed by firmware.

The control unit 602 controls electric power applied to the heater 15H via the head amplifier IC 30. The control unit 602 also can control the power applied to the heater 15H based on an instruction and a measurement result from a measurement unit 604, described later. The control amount can be expressed by a DAC value. For instance, if the control amount has a minimum value, namely, has a DAC value of 0, the protrusion is minimum, and the flying height is maximum.

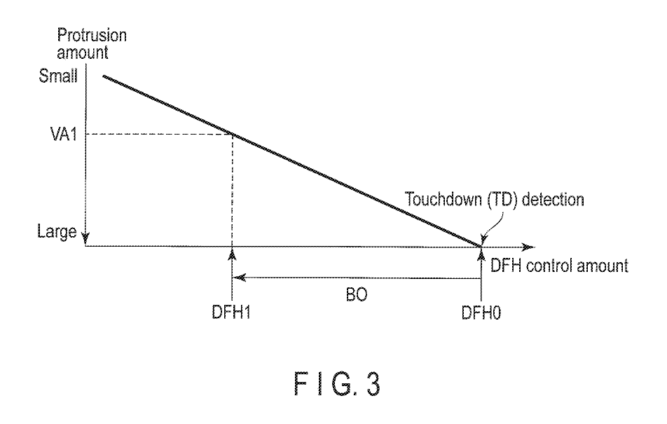

FIG. 3 is a conceptual view for explaining a method of adjusting the control amount based on a measurement result. In FIG. 3, the horizontal axis represents the control amount in measurement, and the vertical axis represents the protrusion. In FIG. 3, the protrusion indicated by the vertical axis increases toward the horizontal axis (downward). As shown in FIG. 3, the protrusion increases in proportion to the control amount. FIG. 3 shows that the head 15 (read/write portion 155) protrudes toward the disk 10 in accordance with an increase in control amount and protrusion. In FIG. 3, reference code DFH0 represents a control amount (hereinafter, referred to as a determination value) obtained when it is determined that touchdown has occurred. For instance, when control amount DFH1 (hereinafter referred to as an adjust amount) adjusted by subtracting a particular difference from determination value DFH0 is applied to the heater, the head shifts from a touchdown state to a state of protrusion VA1. The particular difference for adjusting determination value DFH0 to adjust amount DFH1 is referred to as a back-off (BO) value. The BO value is a fixed value determined based on, for example, a result of measurement beforehand executed on a particular number of population. Alternatively, the BO value may be set by, for example, pre-recording an arbitrary frequency pattern and analyzing the frequency component of a signal read by the head 15 (read head 15R). As described above, the control unit 602 can refer to, for example, determination value DFH0 during read/write operation, calculate adjust amount DFH1 by subtracting the back-off value from determination value DFH0, and apply power corresponding to adjust amount DFH1 to the heater 15H via the head amplifier IC 30.

The measurement unit 604 executes touchdown measurement by various processes. The measurement unit 604 divides the recording area (for example, tracks or cylinders) of the disk 10 into a plurality of circumferential measurement areas (hereinafter, referred to simply as areas). The area is a unit of touchdown measurement execution, and is formed of one or more sectors. The measurement unit 604 selects, from the plurality of areas, an area where touchdown measurement is executed. The measurement unit 604 adjusts a control amount applied to the selected area. For instance, the measurement unit 604 adjusts the applied control amount area by area via the control unit 602. When the head 15 is brought into contact with the disk 10 as a result of adjustment of the control amount, the measurement unit 604 determines that touchdown has occurred, based on a detection criterion (detection index) employed in a particular touchdown detection method. For instance, the measurement unit 604 compares, with the detection criterion, a detection value obtained by a particular touchdown detection method, and determines that touchdown has occurred, if the detection value exceeds the detection criterion. At this time, the measurement unit 604 acquires, as a determination value, a control amount applied when determining occurrence of touchdown. When determining occurrence of touchdown, the measurement unit 604 saves a measurement result, such as the determination value, in a system area on the disk 10. Alternatively, the measurement unit 604 may save the measurement result in the nonvolatile memory 80. Moreover, the measurement unit 604 may timely save the measurement result in the system area on the disk 10 or in the nonvolatile memory 80, after temporarily saving the same in the volatile memory 70.

The measurement unit 604 can detect touchdown by some known methods. In the embodiment, it is assumed that the measurement unit 604 detects touchdown using an HDI sensor S1. In this case, the measurement unit 604 detects touchdown by monitoring a change (detection value) in a signal (indicating a resistance) from the HDI sensor S1. For example, the measurement unit 604 determines that touchdown has occurred, if the change in the signal output from the HDI sensor S1 exceeds the detection criterion.

The measurement unit 604 can also detect touchdown by other known methods. As an example, the measurement unit 604 can detect touchdown by monitoring a position error signal (position error signal [PES]) of the head 15 with respect to the radial direction of the disk 10. For example, if the level of the PES or a change (detection value) in the PES exceeds a threshold (detection criterion), the measurement unit 604 determines that touchdown has occurred. As other examples, the measurement unit 604 may detect touchdown by referring, as a detection value, to the amplitude of a read signal, the value of servo gain control (SVGA), servo variable gain amplifier (VGA) or data VGA, or a control signal from the VCM 14. Furthermore, the measurement unit 604 may detect touchdown by referring, as a detection value, a timestamp as a time interval between servo areas. Yet further, if in a test process in the manufacture of an HDD, an acoustic emission (AE) sensor can be used, the measurement unit 604 may detect vibration of the head due to touchdown as a detection value, using the AE sensor. For example, the measurement unit 604 can detect vibration of the head 15 using the AE sensor installed in the actuator, thereby detecting touchdown based on the detected vibration.

Note that since touchdown is determined based on the above-mentioned detection criterion (detection index) of a detection method, the absolute value of the determination value may differ between detection methods associated with touchdown measurement.

(Touchdown Measurement Method)

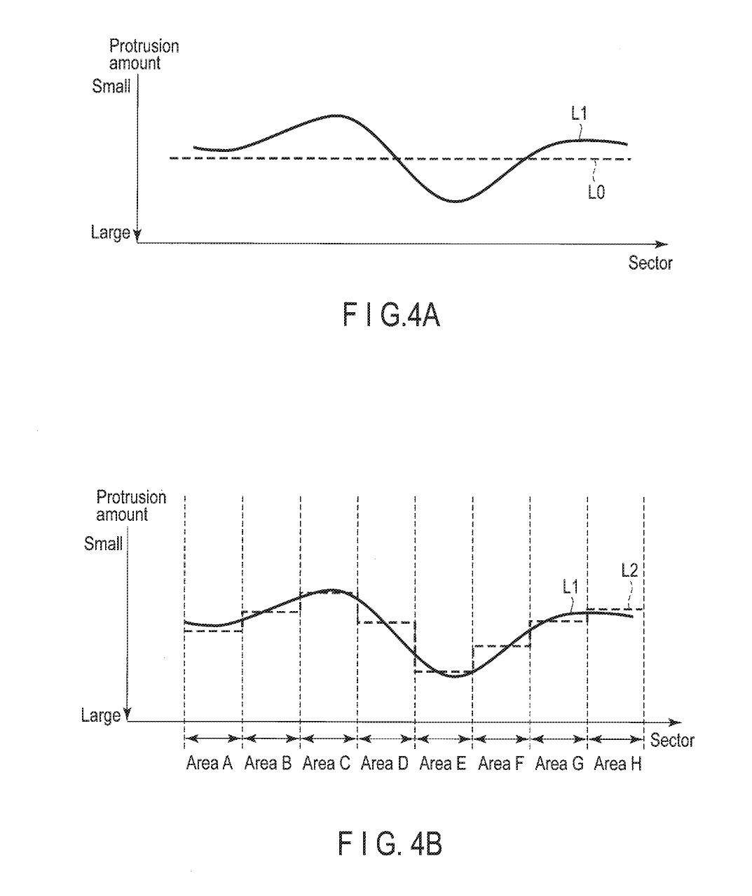

FIG. 4A is a diagram showing an example of a protrusion distribution obtained when a particular control amount is applied over one track circumference, and an example of an ideal protrusion distribution in DFH control. FIG. 4B is a diagram showing an example of a protrusion distribution obtained when the control amount is adjusted in each of areas into which one track circumference is divided, and an example of an ideal protrusion distribution in DFH control. In FIG. 4A, reference mark L0 indicates an example of distribution (variation) in the protrusion of the head 15 obtained when a particular control amount is applied over one track circumference. In FIGS. 4A and 4B, reference mark L1 indicates an example of distribution (variation) in the ideal protrusion of the head 15 in DFH control. In FIG. 4B, reference mark L2 indicates an example of distribution (variation) of the protrusion of the head 15 when the control amount is adjusted area by area. In FIGS. 4A and 4B, the horizontal axis represents the sector position on the disk 10, and the vertical axis represents the protrusion of the head 15. Further, in FIGS. 4A and 4B, the sector number is increased from sector number 0 along the horizontal axis in a direction indicated by the arrow.

When a particular control amount is applied over one track circumference, protrusion distribution L1 differs from protrusion distribution L0 as shown in FIG. 4A. Therefore, even when particular power corresponding to the particular control amount is applied to the heater 15H over one track circumference, the head 15 may contact a certain sector and may be kept out of contact from another sector. During touchdown measurement, the head 15 may be brought into excessive contact with the disk 10 in a sector of a greatest protrusion. Excessive contact between the head 15 and the disk 10 may be a factor of wear in the head 15, a flaw in the disk 10, and other damage.

In contrast, when control amounts adjusted area by area are applied to respective areas into which one track is divided, protrusion distribution for overcoming variation in the level of the head 15 due to, for example, an external factor on the disk 10 can be set as shown in FIG. 4B. Namely, protrusion distribution L1 can be made to approximate protrusion distribution L2. Thus, the head 15 can be prevented from being brought into excessive contact with the disk 10, by adjusting the protrusion distribution of the head 15 area by area, using control amounts measured in respective areas into which one track is divided.

A description will now be given of an example of the touchdown measurement method for the magnetic disk device 1.

The measurement unit 604 of the magnetic disk device 1 divides one track into a plurality of areas, and performs touchdown measurement area by area. At this time, the measurement unit 604 adjusts the control amount area by area. For instance, as shown in FIG. 4B, the measurement unit 604 divides one track into seven areas (areas A, B, C, D, E, F, G and H), and performs touchdown measurement area by area.

Firstly, the measurement unit 604 applies a sufficiently small control amount (initial control amount) at which touchdown does not occur, and starts touchdown detection by a particular touchdown detection method over one track (namely, over all divided areas). The protrusion (initial protrusion) of the head 15 obtained when the initial control amount is applied is kept constant in all areas of one track when touchdown does not occur. The measurement unit 604 iterates processing of increasing the control amount at a particular rate whenever the disk is rotated by a particular number of rotations, with the head kept over one track, and comparing the detected value with the detection criterion area by area. For example, the measurement unit 604 gradually increases the control amount from the initial control amount whenever the disk is rotated by one rotation, with the head kept over one track, thereby gradually increasing power applied to the heater 15H and hence gradually increasing the protrusion of the head 15. If the head 15 contacts the disk 10 in particular area and the detection value therein exceeds the detection criterion, the measurement unit 604 determines that touchdown has occurred in the particular area. The measurement unit 604 acquires, as a determination value, the control amount applied during the determination, and sets a flag (measurement end flag) indicating that the touchdown measurement in the particular area has finished. The measurement unit 604 may save, in a system area on the disk 10, data indicating an area where the measurement end flag is set. Alternatively, the measurement unit 604 may save, in the nonvolatile memory 80, the data indicating the area with the measurement end flag. Moreover, the measurement unit 604 may timely save the data indicating the area with the measurement end flag in the system area on the disk 10 or in the nonvolatile memory 80, after temporarily saving the result of measurement in the volatile memory 70.

After determining touchdown in the particular area, the measurement unit 604 sets the control amount higher than the determination value acquired in the particular area, and performs touchdown measurement on the other areas in the one track, using the set control amount. When the particular area is again reached, the measurement unit 604 refers to the measurement end flag and the determination value, and applies the determination value to the particular area, thereby adjusting the protrusion therein. Until finishing touchdown measurement in all areas, the measurement unit 604 continues touchdown measurement. By thus acquiring a determination value and adjusting a protrusion area by area, the measurement unit 604 can perform touchdown measurement with appropriate protrusions corresponding to the ideal protrusions of the head 15 that compensate for the shape of the disk 10. Therefore, the measurement unit 604 can perform touchdown measurement, while suppressing excessive contact between the head 15 and the disk 10. As a result, during touchdown measurement, wear of the head 15, a flaw of the disk 10, and other damage can be minimized.

Although in the embodiment, the measurement unit 604 acquires a determination value whenever detecting touchdown, it may perform a plurality of touchdown measurements on one track during a plurality of rotations of the disk, thereby acquiring, as a determination value for a plurality of areas, the average of determination values detected area by area.

In touchdown measurement, if the number of sectors constituting each area (the size of each area) is too small, this may influence the accuracy of touchdown measurement, or may cause a follow-up delay based on a response time needed until adjustment of the protrusion of the head 15 is completed. In contrast, if the number of sectors constituting each area is too large, an ideal protrusion distribution cannot be followed. Accordingly, it is desirable that the number of sectors constituting each area is set to a value that is sufficiently greater than a range based on the response time needed until adjustment of the protrusion of the head 15 is completed, and that enables the ideal protrusion distribution to be followed. In addition, the number of sectors constituting each area may be set beforehand, or may be arbitrarily set whenever touchdown measurement is performed.

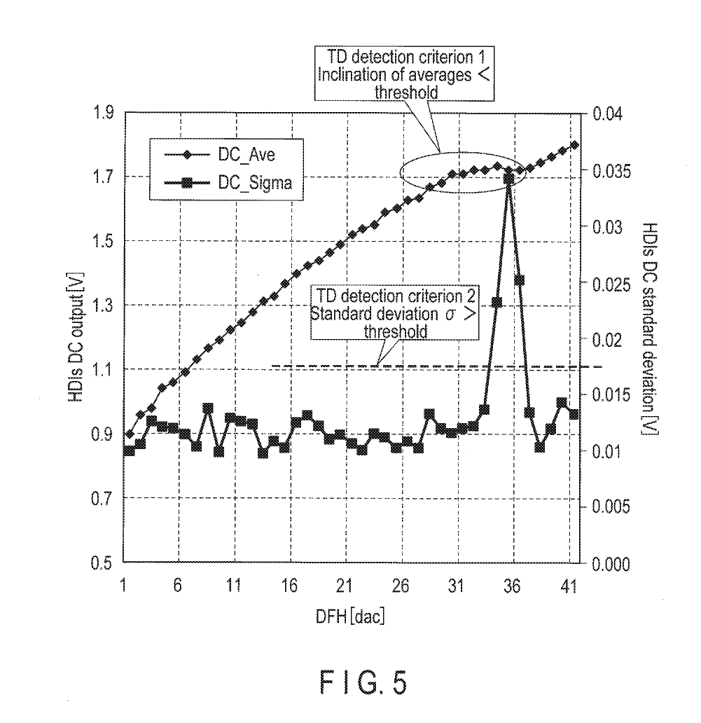

FIG. 5 is a diagram showing an example of the detection criterion. Referring to FIG. 5, a description will be given of a method of detecting touchdown, using the direct current (DC) output of the HDI sensors (HDIs) S1. The touchdown detection method of the embodiment includes a method of detecting touchdown using the alternate current (AC) output of the HDI sensors S1, or a method of detecting touchdown using a time stamp, an SAGC signal or a PES signal. In FIG. 5, the horizontal axis represents a control amount, and the vertical axis represents the average or standard deviation of DC output values acquired servo-sector by servo-sector. The servo sector refers to an area that includes a servo area where servo data is written, and a data area interposed between the servo area and a servo area circumferentially adjacent thereto. In FIG. 5, when touchdown (TD) detection criterion 1 is used, the measurement unit 604 determines that a touchdown detection condition is satisfied, when the inclination of the averages of DC output values (control amounts) is not more than a threshold. Further, when TD detection criterion 2 is used, the measurement unit 604 determines that a touchdown detection condition is satisfied, when the standard deviation of DC output values (control amounts) is not less than a threshold. In the embodiment, the measurement unit 604 performs a determination associated with the touchdown detection condition area by area, using these detection criterions. The detection criterions shown in FIG. 5 are merely examples, and a detection criterion other than detection criterions 1 and 2 may be used in the touchdown detection of the embodiment.

(Protrusion Control Method During Touchdown Measurement)

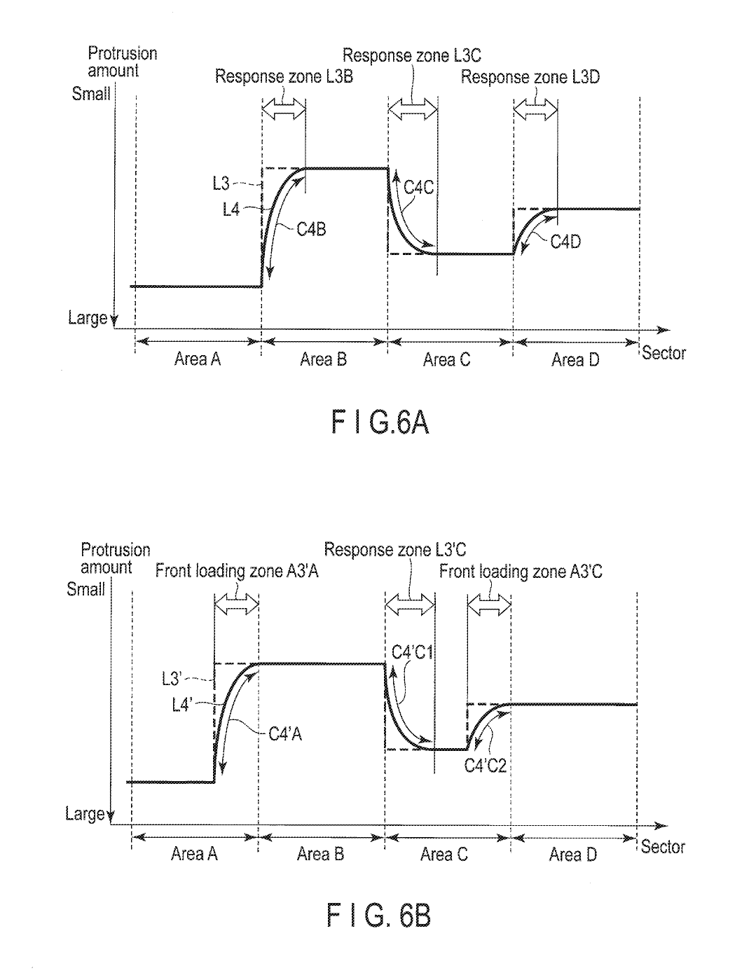

FIG. 6A is a diagram for roughly explaining the relationship between the area and the protrusion obtained when touchdown measurement is performed area by area. FIG. 6B is a diagram for roughly explaining the relationship between the area and the protrusion obtained when the control amount is adjusted earlier than in the case of FIG. 6A. In FIG. 6A, broken line L3 indicates distribution (variation) of control amounts detected area by area in DFH control, and solid line L4 indicates distribution (variation) of actual protrusions of the head 15 in DFH control. In FIG. 6B, broken line L3′ indicates distribution (variation) of control amounts detected area by area obtained when the adjustment of the control amounts is performed earlier than the case indicated by broken line L3. Similarly, solid line L4′ indicates distribution (variation) of actual protrusions obtained when the adjustment of the control amounts is performed earlier than the case indicated by solid line L4. Further, in FIGS. 6A and 6B, one track is divided into four areas (areas A, B, C and D). In FIGS. 6A and 6B, the horizontal axis represents the position of each sector (namely, the circumferential position of each sector on the disk 10), and the vertical axis represents the protrusion of the head 15. Further, in FIGS. 6A and 6B, it is assumed that the disk 10 is rotated from area A to area D. In addition, in FIGS. 6A and 6B, the sector number of each area is increased from the leftmost sector (sector number: 0) in area A along the horizontal axis.

When adjusting the control amount, a certain time constant (response time) is required until a protrusion corresponding to a control amount before adjustment reaches an adjusted control amount. For instance, if the control amount is adjusted when the area is switched from area A to area B, response zone L3B where the protrusion smoothly varies as indicated by curve C4B occurs until the protrusion of area A reaches the protrusion of area B, as is shown in FIG. 6A. Similarly, if the control amount is adjusted when the area is switched from area C to area D, response zone L3D where the protrusion smoothly varies as indicated by curve C4D occurs until the protrusion of area C reaches the protrusion of area D, as is shown in FIG. 6A. Thus, when the protrusion is reduced by reducing the control amount in DFH control, distribution L4 of the actual protrusions of the head 15 delays by a certain period with respect to distribution L3 of the control amounts in each area. Moreover, response zone L3C where the protrusion smoothly varies as indicated by curve C4C occurs until the protrusion of area B reaches the protrusion of area C, as is shown in FIG. 6A. Thus, even when increasing the protrusion by increasing the control amount in DFH control, distribution L4 of the actual protrusions of the head 15 delays by a certain period with respect to distribution L3 of the control amounts in each area. In FIG. 6A, if the control amount of the latter half zone other than response zone L3B of area B is a determination value, the protrusion in response zone L3B of area B is greater than that obtained when the determination value in area B is applied. Similarly, in FIG. 6A, if the control amount of the latter half zone other than response zone L3D of area D is a determination value, the protrusion in response zone L3D of area D is greater than that obtained when the determination value in area D is applied. Namely, in response zones L3B and L3D of FIG. 6A, the head 15 excessively protrudes toward the disk 10. Therefore, in these zones, wear of the head 15 and damage of the disk 10 may occur. If the control amount is further increased during touchdown measurement of areas A and C, the head 15 will further protrude toward the disk 10 in response zones L3B and L3D.

In view of the above, the control unit 602 determines, during touchdown measurement, whether a subsequent area adjacent to an area (hereinafter, referred to as the current area) including the position where the head 15 is currently positioned has already been subjected to touchdown detection, referring to, for example, the touchdown measurement result of the subsequent area. If the subsequent area has already been subjected to touchdown detection, the control unit 602 adjusts the control amount (protrusion) earlier by a period not less than the response time. This earlier period may be constant or different between areas. Further, the earlier period may be a certain period given from measurements, or a period determined from a change in the control amount. For example, as shown in area A of FIG. 6B, the control unit 602 adjusts the control amount to the determination value of area B earlier by a period corresponding to response zone L3B of area B, namely, when zone (front-loading zone) A3′A of area A is reached. Similarly, as shown in area C of FIG. 6B, the control unit 602 adjusts the control amount to the determination value of area D earlier by a period corresponding to response zone L3D of area D, namely, when zone (front-loading zone) A3′C of area C is reached. Thus, when the control amount of a current area is greater than the determination value of a subsequent area, the control unit 602 adjusts the control amount to the determination value of the subsequent area earlier by a period not less than a response period until the protrusion in the current area reaches that of the subsequent area.

If the control amount of the current area is greater than the determination value of the subsequent area, the control unit 602 can also adjust, in an earlier stage, the applied control amount to an adjustment value obtained by subtracting a back-off value from the determination value of the subsequent area. For facilitating the description, it is assumed that when the control amount of the current area is greater than the determination value of the subsequent area, the control unit 602 adjusts the applied control amount to the determination value of the subsequent area in an earlier stage.

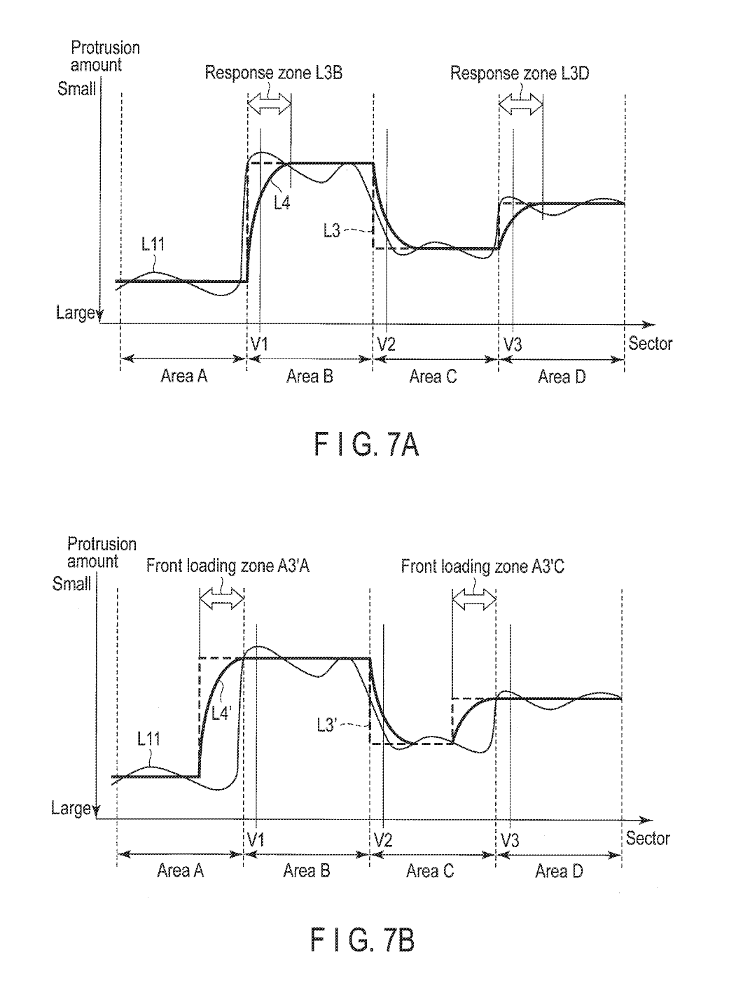

FIG. 7A is a diagram showing a case where an example of a protrusion distribution obtained by actual measurement is added to the touchdown measurement data shown in FIG. 6A. FIG. 7B is a diagram showing a case where an example of a protrusion distribution obtained by actual measurement is added to the touchdown measurement data shown in FIG. 6B. In FIGS. 7A and 7B, solid lines L11 indicate examples of protrusion distributions obtained by the actual measurements. That is, solid lines L11 indicate examples of unevenness of the disk 10 obtained by the touchdown measurement, or of variations in the protrusion of the head 15 during the touchdown measurement. In FIG. 7A, the control unit 602 adjusts the control amount when the area is switched form one to another, as in the case of FIG. 6A. At this time, at position V1 in area B or at position V3 in area D in FIG. 7A, distribution L4 of the protrusion of the head 15 obtained by DFH control exhibits sufficiently higher values than distribution L11 of protrusions obtained by touchdown. That is, at these positions, the head 15 may be brought into excessive contact with the disk 10.

In contrast, in FIG. 7B, the control unit 602 adjusts the control amount earlier by a period corresponding to response zone L3B in area B in FIG. 7A, when zone (front-loading zone) A3′A in area A is reached. At this time, at position V1 in area B or at position V3 in area D in FIG. 7B, distribution L4′ of the protections obtained by DFH control exhibits substantially the same values as distribution L11 of protrusions obtained by touchdown. That is, at these positions, the head 15 does not excessively contact the disk 10. Therefore, when the control amount is adjusted earlier as shown in FIG. 7B, the head 15 is prevented from excessive contact with the disk 10. As a result, wear of the head 15, a flaw of the disk 10, and other damage, can be suppressed.

(Processing Procedure of Touchdown Measurement)

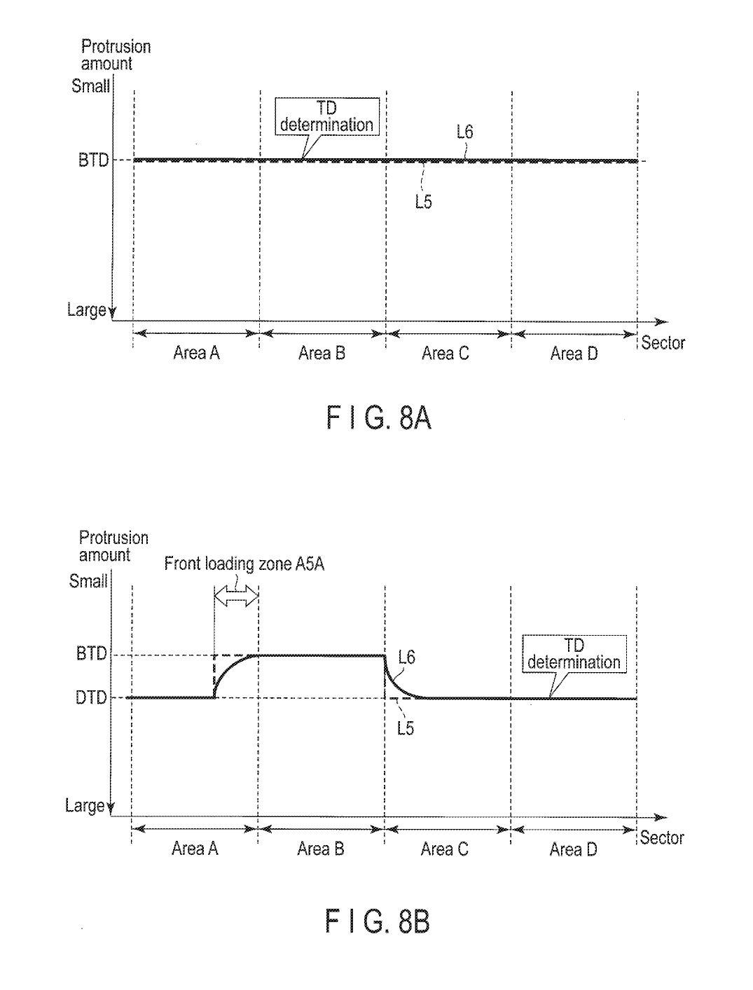

A description will now be given of an example of a processing procedure of touchdown measurement in the embodiment. FIGS. 8A, 8B, 8C and 8D are views for roughly explaining an example of a processing procedure of touchdown measurement in the embodiment. Assume here that the touchdown measurement processing is executed in the order of FIGS. 8A to 8D. Broken line L5 indicates distribution of ideal protrusions, and solid line L6 indicates distribution (variation) of protrusions obtained by DFH control. In FIGS. 8A to 8D, one track is divided into four areas (areas A, B, C and D). In FIGS. 8A to 8D, the horizontal axis represents the sector position of the disk 10, and the vertical axis represents the protrusion of the head 15. In these figures, it is assumed that the disk 10 is rotating from area A toward the area D. In addition, in FIGS. 8A to 8D, the sector number is increased from the leftmost sector (sector number: 0) in area A along the horizontal axis in a direction indicated by the arrow. In touchdown measurement of the embodiment, the MPU 60 executes touchdown measurement area by area, with the control amount increased from a sufficiently low initial value. In this description, a case where touchdown detection is repeatedly executed until all areas are subjected to determination associated with touchdown.

Firstly, the MPU 60 applies the same initial control amount to all areas. FIG. 8A shows the case where the same control amount is applied to all areas. In FIG. 8A, reference mark BTD indicates a protrusion detected when the initial control amount is applied. Assume here that the MPU 60 has detected touchdown in area B of FIG. 8A. The MPU 60 acquires a measurement result, such as a determination value, and uniformly increases a control amount applied to the areas other than area B. At this time, the protrusion in area B is maintained at protrusion BTD.

FIG. 8B is a view showing a case where the control amount for the areas other than area B is uniformly increased from the control amount shown in FIG. 8A. In FIG. 8B, reference mark DTD indicates a protrusion detected when a control amount to be applied to the areas other than area B is applied. As shown in FIG. 8B, the MPU 60 earlier adjusts the control amount to the determination value (which corresponds to protrusion BTD) of area B when front-loading zone A5A of area A is reached. Assume here that the MPU 60 detects touchdown in area D of FIG. 8B. At this time, the MPU 60 acquires a measurement result and uniformly increases the control amount applied to the areas other than areas B and D. At this time, the protrusion of area B is maintained at protrusion BTD, and the protrusion of area D is maintained at protrusion DTD.

FIG. 8C shows a case where the control amount of areas A and C is uniformly increased from the control amount shown in FIG. 8B. In FIG. 8C, reference mark CTD indicates a protrusion obtained by the control amount applied to areas A and C. As shown in FIG. 8C, the MPU 60 earlier adjusts the control amount to the determination value of area B when front-loading zone A5A of area A is reached, adjusts the control amount when area C is reached, and earlier adjusts the control amount to the determination value (which corresponds to protrusion DTD) of area D when front-loading zone A5C of area C is reached. Assume here that the MPU 60 has detected touchdown in area C of FIG. 8C. The MPU 60 acquires a measurement result and increases the control amount applied to area A. At this time, the protrusion of area B is maintained at protrusion BTD, the protrusion of area D is maintained at protrusion DTD, and the protrusion of area C is maintained at protrusion CTD.

FIG. 8D shows a case where the control amount of area A is increased from the control amount shown in FIG. 8C. In FIG. 8D, reference mark ATD indicates a protrusion obtained by the control amount applied to area A. As shown in FIG. 8D, the MPU 60 adjusts the control amount in area A, earlier adjusts the control amount to the determination value of area B when front-loading zone A5A of area A is reached, adjusts the control amount to the determination value (which corresponds to protrusion CTD) of area C when area C is reached, and earlier adjusts the control amount to the determination value of area D when front-loading zone A5C of area C is reached. Assume here that the MPU 60 has detected touchdown in area A of FIG. 8D. The MPU 60 acquires a measurement result, checks that determination as to touchdown has been executed in all areas, and finishes the series of touchdown measurements.

In addition, the above-described processing of adjusting the control amount in each area, as shown in FIG. 8D, is also applicable to control of the flying height of the heads 15 during, for example, read/write operation. Namely, the MPU 60 controls, during, for example, read/write operation, the control amount applied area by area, referring to the determination value acquired during touchdown measurement. The MPU 60 calculates the control amount by subtracting a back-off value from the determination value area by area. If the determination value of a subsequent area is lower than that of a current area, the MPU 60 applies an adjusted value earlier by a period not less than the response period of the head 15. For instance, as shown in FIG. 8D, the MPU 60 sets front-loading zone A5A in area A before the position where area A is switched to area B, and applies the adjusted value when front-loading zone A5A is reached. This way of control can prevent excessive contact between the head 15 and the disk 10 during read/write operation.

The MPU 60 may save, in the nonvolatile memory 80, data associated with a measurement result, such as the determination value. Moreover, the MPU 60 may timely save the data associated with the measurement result in the system area on the disk 10 or in the nonvolatile memory 80, after temporarily saving the same in the volatile memory 70.

(Operation During Touchdown Measurement)

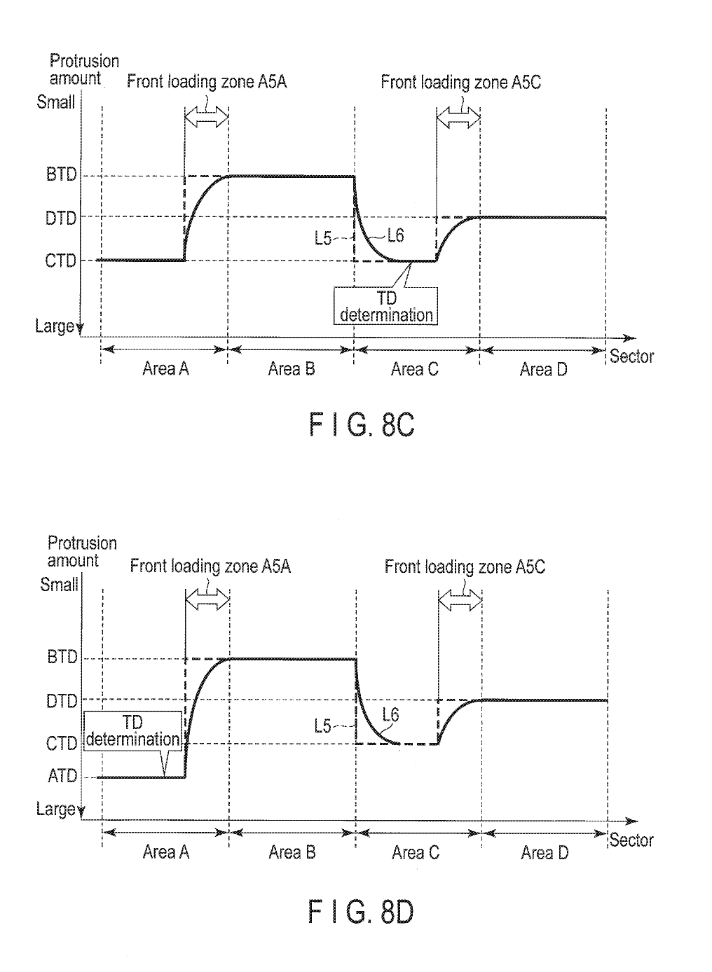

FIG. 9 is a flowchart showing an operation performed during touchdown measurement in the magnetic disk device 1.

In B901, the MPU 60 sets a sufficiently small control amount (initial control amount) applied at the start of touchdown measurement.

In B902, the MPU 60 divides one track into a plurality of areas, and selects, from the areas, a first area where touchdown measurement is started.

In B903, the MPU 60 refers to a measurement end flag corresponding to an area (current area) that includes a position in which the head 15 is currently positioned for touchdown measurement, thereby determining whether touchdown has occurred in the current area.

If it is determined in B903 that touchdown does not occur (NO in B903), the processing proceeds to B904. In contrast, if it is determined that touchdown has occurred (YES in B903), the processing proceeds to B913.

In B904, the MPU 60 acquires, from, for example, the system area on the disk 10, data indicating the control amount (in this case, the initial control amount) applied to the current area.

In B905, the MPU 60 adjusts the control amount (initial control amount) corresponding to the current area, and starts touchdown measurement.

In B906, the MPU 60 uses a particular touchdown detection method to compare a detection value detected in each sector of the current area with a detection criterion.

In B907, the MPU 60 compares the detection value with the detection criterion, thereby determining whether touchdown has occurred. If touchdown is detected (YES in B907), in B908, the MPU 60 sets a measurement end flag in the current area, and saves, as a determination value in the system area on the disk 10, a control amount obtained when touchdown is detected. The MPU 60 may save, in the nonvolatile memory 80, data associated with a measurement result, such as the determination value. Moreover, the MPU 60 may timely save the data associated with the measurement result in a system area on the disk 10 or in the nonvolatile memory 80, after temporarily saving the same in the volatile memory 70. In contrast, if determining that touchdown does not occur (NO in B907), the MPU 60 proceeds to B909.

In B909, the MPU 60 refers to the measurement end flag of an area (subsequent area) subsequent to the current area and including a position where the head 15 is subsequently positioned for touchdown measurement, thereby determining whether touchdown has occurred in the subsequent area. In B909, if determining that the current area is the last area of one track, the MPU 60 refers to the measurement end flag of the first area (regarded as a subsequent area) of the one track, thereby determining whether touchdown has occurred in the first area.

If determining from the measurement end flag of the subsequent area that touchdown does not occur therein (NO in B909), the MPU 60 proceeds to B921.

In contrast, if determining from the measurement end flag of the subsequent area that touchdown has occurred therein (YES in B909), the MPU 60 acquires the stored determination value of the subsequent area in B910. The MPU 60 can also acquire a current determination value from the nonvolatile memory 80.

In B911, the MPU 60 acquires the determination value of the subsequent area to earlier adjust the control amount to the acquired determination value, and proceeds to B918.

In contrast, if determining in B903 that touchdown has occurred (YES in B903), in B912, the MPU 60 acquires the determination value of the current area from, for example, the system area on the disk 10. The MPU 60 can also acquire the current determination value from the nonvolatile memory 80.

In B913, the MPU 60 adjusts the control amount to the acquired determination value.

In B914, the MPU 60 refers to the measurement end flag of the subsequent area to determine whether touchdown has occurred therein. If the current area is the last area of one track, the MPU 60 refers to the measurement end flag of the first area (regarded as a subsequent area) of the one track, thereby determining whether touchdown has occurred in the first area.

If determining from the measurement end flag of the subsequent area that touchdown does not occur therein (NO in B914), the MPU 60 proceeds to B918. In contrast, if determining that touchdown has occurred therein (YES in B914), in B915, the MPU 60 acquires the determination value of the subsequent area stored in the system area on the disk 10, and proceeds to B916. The MPU 60 can also acquire the current determination value from the nonvolatile memory 80.

In B916, the MPU 60 determines whether the determination value of the subsequent area is lower than the determination value of the current area.

If determining that the determination value of the subsequent area is not lower than the determination value of the current area (NO in B916), the MPU 60 proceeds to B918. In contrast, if determining that the determination value of the subsequent area is lower than the determination value of the current area (YES in B916), in B917, the MPU 60 earlier adjusts the control amount to the determination value of the subsequent area.

In B918, the MPU 60 determines whether the current area is the last area of the one track. If determining that the current area is not the last area (NO in B918), in B919, the MPU 60 switches the current area to the subsequent area, and returns to B903. If determining that the current area is the last area (YES in B918), in B920, the MPU 60 determines whether all areas have been subjected to touchdown determination.

If determining that all areas have not yet been subjected to touchdown determination (NO in B920), in B921, the MPU 60 increases the control amount, and returns to B902. In contrast, if determining that all areas have been subjected to touchdown determination (YES in B920), the MPU 60 finishes the touchdown measurement processing.

(Manufacturing Process of Magnetic Disk Device)

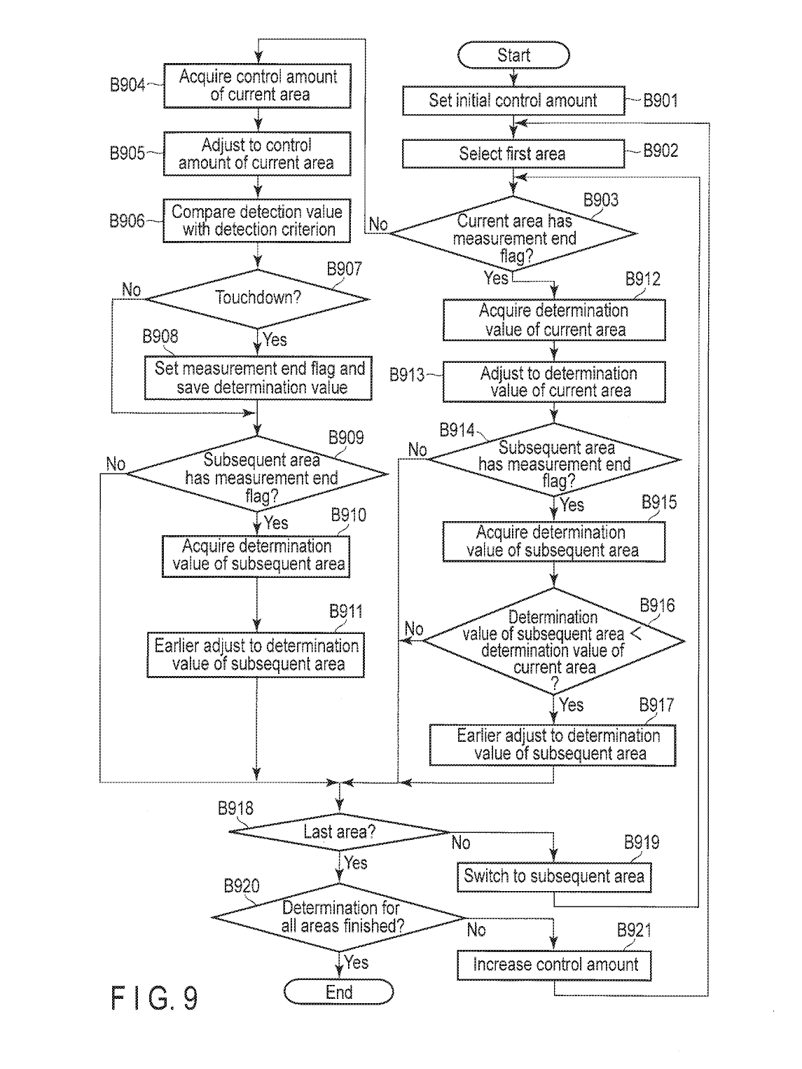

Referring now to FIG. 10, a description will be given of part of a process of manufacturing the magnetic disk device 1.

FIG. 10 is a flowchart showing part of the process of manufacturing the magnetic disk device 1.

Upon starting the manufacturing process, after a particular step, the disk 10 is incorporated into the housing 100 of the magnetic disk device 1 in B1001.

In B1002, the touchdown measurement shown in FIG. 9 is executed.

In B1003, read/write operation is adjusted (including testing and inspection), and the manufacturing process is finished through particular steps.

(Method of Adjusting Control Amount During Read/Write Operation)

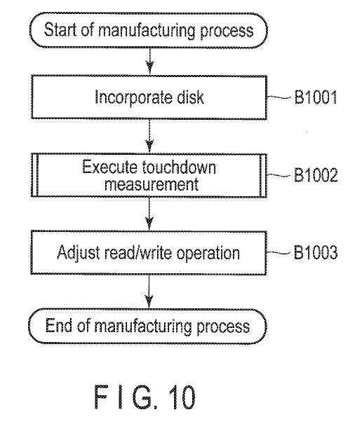

Referring then to FIG. 11, a description will be given of a method of adjusting the control amount during read/write operation of the magnetic disk device 1. The magnetic disk device 1 adjusts the control amount during the read/write operation, referring to determination values acquired by touchdown measurement, as is shown in FIG. 8D. Assume here that the magnetic disk device 1 stores, in a storage medium, such as the system area on the disk 10, the determination values of areas on the disk 10 obtained by the touchdown measurement shown in FIG. 9.

FIG. 11 is a flowchart showing the method of adjusting the control amount during the read/write operation.

Upon starting the read/write operation, in B1101, the MPU 60 selects a first sector where it executes the read/write operation, and positions (or moves) the head 15 on the selected first sector.

In B1102, the MPU 60 acquires the determination value of the current area from, for example, the system area of the disk 10. The MPU 60 can also acquire the determination value from the nonvolatile memory 80.

In B1103, the MPU 60 calculates an adjust amount by subtracting a BO value from the determination value of the current area, and adjusts the control amount to the adjust amount of the current area.

In B1104, the MPU 60 acquires, from, for example, the system area on the disk 10, the determination value of the subsequent area adjacent along the circumference of the disk. The measurement unit 604 can also acquire a determination value from the nonvolatile memory 80.

In B1105, the MPU 60 compares the determination value of the current area with the determination value of the subsequent area. If determining that the determination value of the subsequent area is lower than the determination value of the current area (YES in B1105), in B1106, the MPU 60 calculates the adjust amount of the subsequent area by subtracting a BO value from the determination value of the subsequent area, and earlier adjusts, to the adjust amount of the subsequent area, the control amount corresponding to power applied to the heater 15H, thereby proceeding to B1107. In contrast, if determining that the determination value of the subsequent area is not lower than the determination value of the current area (NO in B1105), the MPU 60 proceeds to B1107.

In B1107, the MPU 60 determines whether the read/write operation should be finished. If the read/write operation should be continued (NO in B1107), in B1108, the MPU 60 switches the current area to the subsequent area, and returns to B1104. In contrast, if the read/write operation should be finished (YES in B1107), the MPU 60 finishes the read/write operation.

According to the embodiment, the magnetic disk device 1 executes touchdown measurement for each of the areas into which one track is divided. Referring to a control amount (determination value) acquired when touchdown is detected by touchdown measurement, the magnetic disk device 1 controls the protrusion of the head 15 in each area. Further, if the determination value of the subsequent area is lower than the determination value of the current area, the magnetic disk device 1 earlier adjusts the control amount to the determination value of the subsequent area. By controlling in this way, the head 15 is prevented from excessively contacting the disk 10. As a result, wear of the head 15, damage of the disk 10, and other damage, can be prevented.

A magnetic disk device and a measurement method according to a modification of the first embodiment will now be described. In the modification of embodiment, elements similar to those of the first embodiment are denoted by corresponding reference numbers, and no detailed description will be given thereof.

### MODIFICATION

Although a magnetic disk device 1 according to the modification of the first embodiment has substantially the same configuration as the first embodiment, it differs in that touchdown measurement processing is executed radially on the disk 10.

The MPU 60 radially divides the disk 10 into a plurality of radial zones, and circumferentially divides the disk 10 into a plurality of circumferential areas (along the circumference of the disk 10). Each zone is an area including a plurality of cylinders (tracks). Moreover, areas, into which each zone is divided circumferentially, will hereinafter be referred to as sections. The MPU 60 selects a particular number of zones from the plurality of zones, and selects a particular number of areas from the plurality of areas. That is, a particular number of sections are selected by a combination of selected zones and areas. The MPU 60 performs touchdown measurement on at least one cylinder included in the selected sections. The MPU 60 calculates the average of determination values (hereinafter, referred to simply as the average) section by section by averaging the determination values acquired in each cylinder. Furthermore, the MPU 60 uses the average of each combination of selected sectors, and interpolates the average of the determination values of sections that were not selected. The MPU 60 saves, in the system area on the disk 10, data indicating the average of the selected sections and the average of the not-selected sections calculated by interpolation. Alternatively, the MPU 60 may save these averages in the nonvolatile memory 80. Moreover, the MPU 60 may timely save them in the system area on the disk 10 or the nonvolatile memory 80, after temporarily saving them in the volatile memory 70.

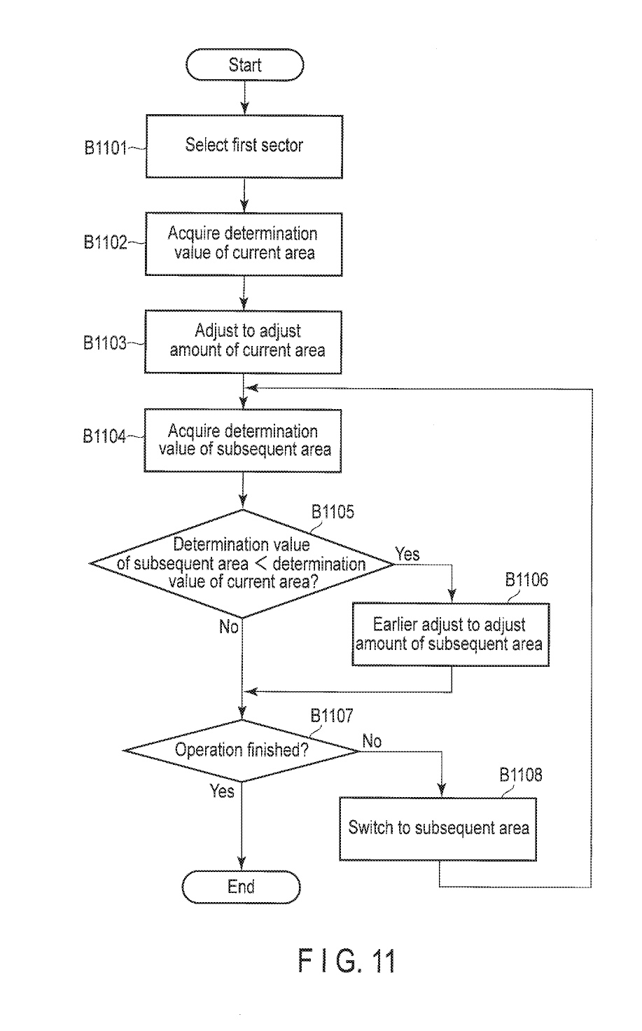

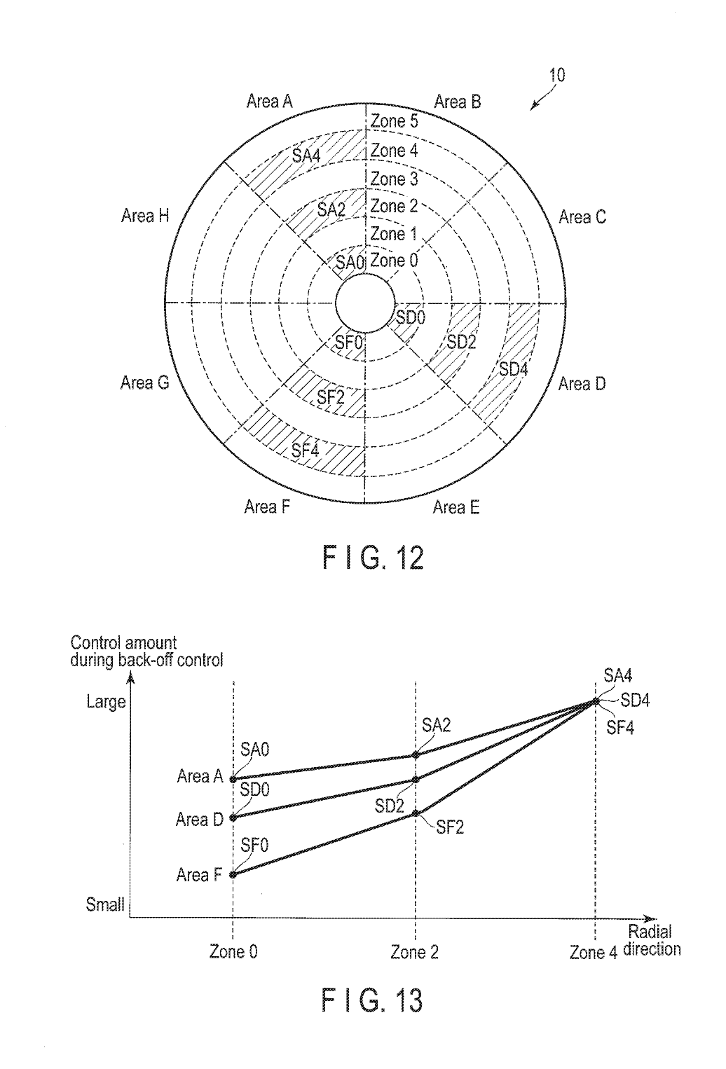

FIG. 12 is a view for conceptually explaining divisions on the disk 10, and FIG. 13 is a view for explaining an example of a method of interpolating control amounts between zones.

In FIG. 12, the disk 10 is radially divided into six radial zones (zone 0, zone 1, zone 2, zone 3, zone 4 and zone 5), and is circumferentially divided into eight circumferential areas (areas A, B, C, D, E, F, G and H). Assume here that touchdown measurement is executed in zones 0, 2 and 4 of each of areas A, D and F. In FIG. 13, the horizontal axis represents the radial direction of the disk 10, and the vertical axis represents a control amount during back-off control. In FIG. 13, along the vertical axis, the control amount increases upwardly from the cross point of the vertical and horizontal axes.

FIG. 13 shows a plurality of control amounts obtained by subtracting a back-off (BO) value from the respective control amounts in the respective sections of each area. Further, in FIG. 13, control amounts (adjust amounts), which are obtained by subtracting the BO value from the average of control amounts in section SA0 of area A, the average of control amounts in section SD0 of area D, and the average of control amounts in section SF0 of area F, are shown on the broken line of zone 0. Similarly, control amounts, which are obtained by subtracting the BO value from the average of control amounts in section SA2 of area A, the average of control amounts in section SD2 of area D, and the average of control amounts in section SF2 of area F, are shown on the broken line of zone 2. Yet similarly, a control amount, which is obtained by subtracting the BO value from the average of control amounts in section SA4 of area A, the average of control amounts in section SD4 of area D, and the average of control amounts in section SF4 of area F, is shown on the broken line of zone 4. In the description below, processing of subtracting the BO value from each average will be referred to as back-off control.

The MPU 60 executes touchdown measurement in zones 0, 2 and 4 of each of areas A, D and F. As shown in FIG. 13, since sections SA0, SD0 and SF0 in zone 0 exhibit different averages, different control amounts are applied to sections SA0, SD0 and SF0 during back-off control. Further, sections SA2, SD2 and SF2 in zone 2 exhibit different averages, as in zone 0. However, in zone 4, there is no difference in control amount between sections SA4, SD4 and SF4.

When interpolating, during back-off control, control amounts of sections where touchdown measurement is not executed, the MPU 60 executes interpolation processing independently area by area. For instance, the MPU 60 performs linear interpolation area by area. More specifically, in area A, the MPU 60 uses the control amounts obtained during back-off control of sections SA0 and SA2, to execute linear interpolation of control amounts for the sections of zone 1 between zones 0 and 2. The MPU 60 saves, in the system area on the disk 10, the control amounts of the interpolated sections in zone 1.

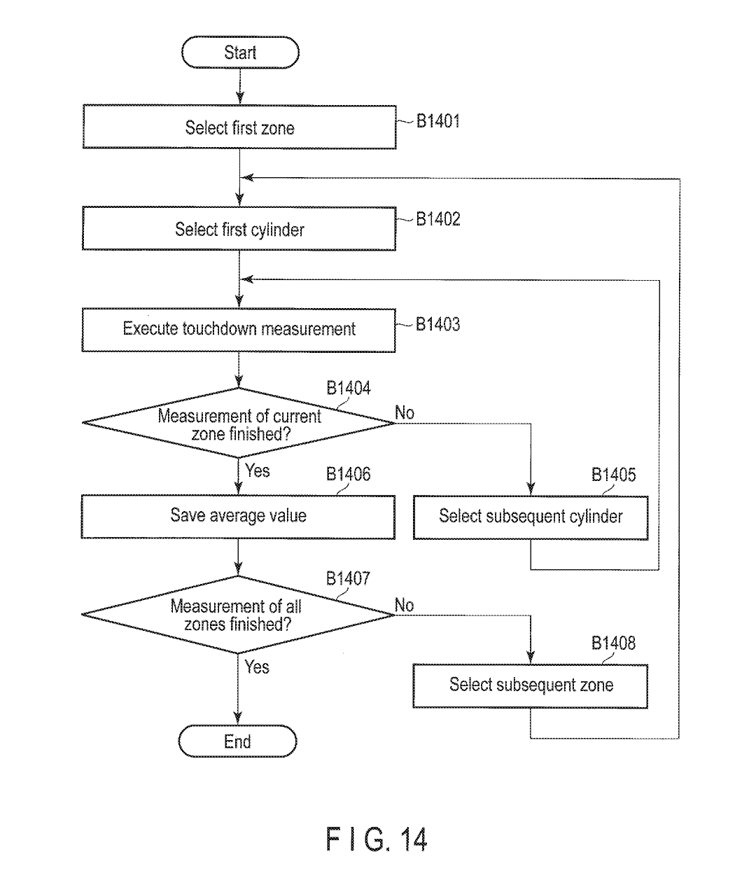

FIG. 14 is a flowchart showing touchdown measurement performed zone by zone. Assume here that the disk 10 is divided into a plurality of radial zones and into a plurality of circumferential areas, and therefore has a plurality of sections.

In B1401, the MPU 60 selects a zone on which the MPU 60 performs measurement first.

In B1402, the MPU 60 selects, from the selected zone, a cylinder on which the measurement is executed.

In B1403, the MPU 60 performs touchdown measurement on the cylinder selected in B1402.

In B1404, the MPU 60 determines whether touchdown measurement on a zone (hereinafter referred to as the current zone) including a cylinder in which touchdown measurement is performed has been finished.

If determining that the touchdown measurement on the current zone is not finished (NO in B1404), the MPU 60 selects a subsequent cylinder in B1405, and returns to B1403.

In contrast, if determining that the touchdown measurement on the current zone is finished (YES in B1404), the MPU 60 acquires the determination values of a particular number of cylinders included in the current zone in B1406. In each section, the MPU 60 calculates the average of the acquired determination values of the cylinders. The MPU 60 saves the calculated average in the system area on the disk 10. Alternatively, the MPU 60 may save the measurement result in the nonvolatile memory 80. Further, the MPU 60 may timely save the measurement result in the system area of the disk 10 or the nonvolatile memory 80, after temporarily saving the same in the volatile memory 70.

In B1407, the MPU 60 determines whether touchdown measurement of all zones selected as measuring targets has been finished. If determining that touchdown measurement of all zones has not been finished (NO in B1407), in B1408, the MPU 60 selects a subsequent zone and returns to B1402.

If determining that touchdown measurement of all zones has been finished (YES in B1407), the MPU 60 finishes the touchdown measurement executed zone by zone on the disk 10.

In addition, the touchdown measurement shown in FIG. 14 may be applied to the manufacturing process shown in FIG. 10.

According to the embodiment, the magnetic disk device 1 radially divides the disk 10 into a plurality of radial zones, and executes touchdown measurement zone by zone. Further, the magnetic disk device 1 executes touchdown measurement cylinder by cylinder on a particular number of cylinders included in each zone, and calculates the average of the determination values of cylinders section by section. Furthermore, the magnetic disk device 1 calculates, by interpolation, the control amounts of zones that are not measured. Thus, the magnetic disk device 1 of the embodiment can perform radial touchdown measurement in a shorter period by selecting areas to measure. Moreover, by calculating the average of determination values section by section, the influence of a singular determination value, which may occur because of, for example, a projection on the disk 10, can be smoothed.

A magnetic disk device and a measurement method according to another embodiment will be described. In this embodiment, elements similar to those of the first embodiment are denoted by corresponding reference numbers, and no detailed description will be given thereof.

### Second Embodiment

Although a magnetic disk device 1 according to a second embodiment has substantially the same configuration as the aforementioned embodiment, it differs in that the boundaries of areas are controlled during touchdown measurement.

The MPU 60 of the second embodiment extends a current area when the determination value of a subsequent area is lower than that of the current area. At this time, the MPU 60 extends the current area by a range greater than a zone (response zone) corresponding to the response period of the head 15.

(Method of Controlling Areas During Touchdown Measurement)

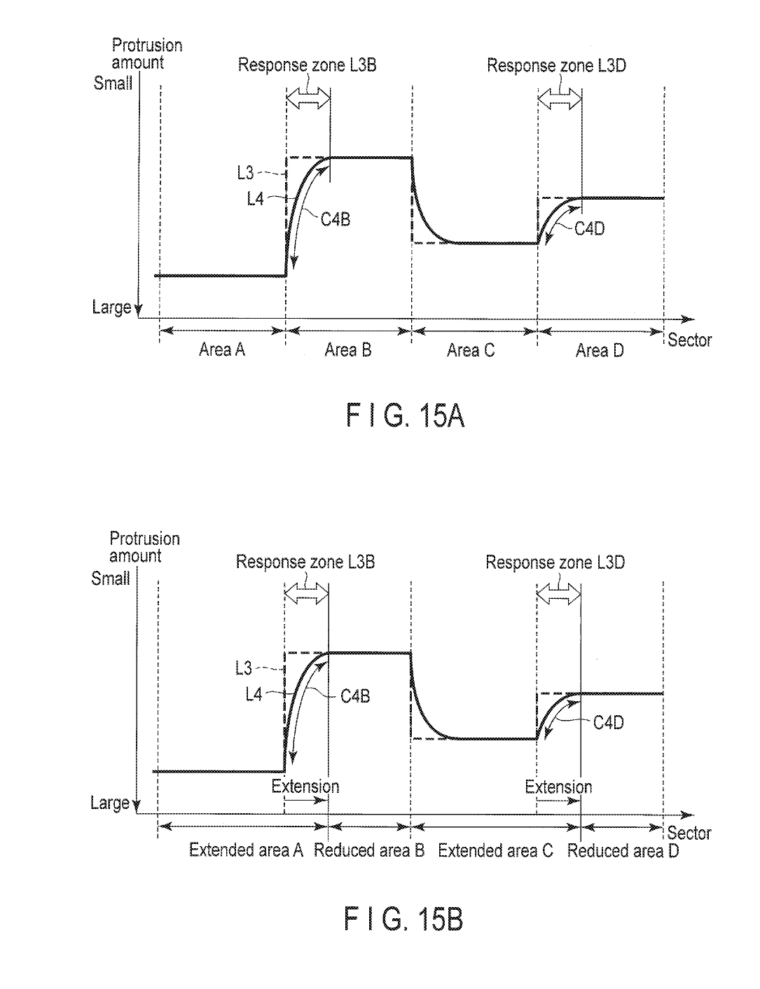

FIG. 15A is a diagram for roughly explaining the relationship between the area and the protrusion obtained when touchdown measurement is executed area by area. FIG. 15B is a diagram for roughly explaining the relationship between the area and the protrusion obtained when the area is extended in FIG. 15A. In FIG. 15A, broken line L3 indicates distribution of ideal protrusions, and solid line L4 indicates distribution of protrusions as a result of DFH control. In FIG. 15B, extended area A indicates an area obtained by circumferentially extending area A of FIG. 15A by a range corresponding to response zone L3B, and extended area C indicates an area obtained by circumferentially extending area C of FIG. 15A by a range corresponding to response zone L3D. In FIGS. 15A and 15B, one track is divided into four areas (areas A, B, C and D). Further, in FIGS. 15A and 15B, the horizontal axis represents the sector position (namely, the circumferential position on the disk 10), and the vertical axis represents the protrusion of the head 15. In FIGS. 15A and 15B, it is assumed that the horizontal axis represents rotation of the disk 10 from area A to area D. In addition, in FIGS. 15A and 15B, the sector number of each area is increased from the leftmost sector (sector number: 0) of area A along the horizontal axis as indicated by the arrow. FIG. 15A is substantially the same as FIG. 6A.

In the second embodiment, when the state of FIG. 15A may be assumed, the MPU 60 extends the current area by a range corresponding to the response zone, and reduces the subsequent area by the extended range corresponding to the response zone.

In the second embodiment, the control unit 602 refers to the measurement end flag to determine whether the subsequent area has been subjected to touchdown detection. If the subsequent area has already been subjected to touchdown detection, the control unit 602 extends the current area by a range corresponding to the response zone. The areas may be extended by the same extended range or by different extended ranges. Further, the extended range may be a beforehand measured range, or may be varied in accordance with a change in control amount. For example, as shown in FIG. 15B, the control unit 602 extends current area A by a range corresponding to response zone L3B of area B of FIG. 15A, thereby forming extended area A. At this time, the control unit 602 reduces current area B by the range corresponding to response zone L3B, thereby forming reduced area B. Similarly, as shown in FIG. 15B, the control unit 602 extends current area C by a range corresponding to response zone L3D of area D, thereby forming extended area C. At this time, the control unit 602 reduces current area D by the range corresponding to response zone L3D, thereby forming reduced area D. Thus, when the control amount of a current area is greater than the determination value of a subsequent area, the control unit 602 extends the current area by a range not smaller than a response zone corresponding to a response period required until the protrusion of the current area reaches the protrusion of the subsequent area.

Moreover, in, for example, response zone L3B of FIG. 15B, the MPU 60 determines whether touchdown has occurred in a sector belonging to original area B in extended area A. Therefore, when determining whether touchdown has occurred in, for example, extended area A, the MPU 60 compares a detection value in the response zone of extended area A with a detection criterion to determine touchdown. Thus, when contact has occurred in response zone L3B or L3D, a touchdown detection criterion set in extended area A is satisfied, whereby excessive contact can be prevented.

(Operation During Touchdown Measurement)

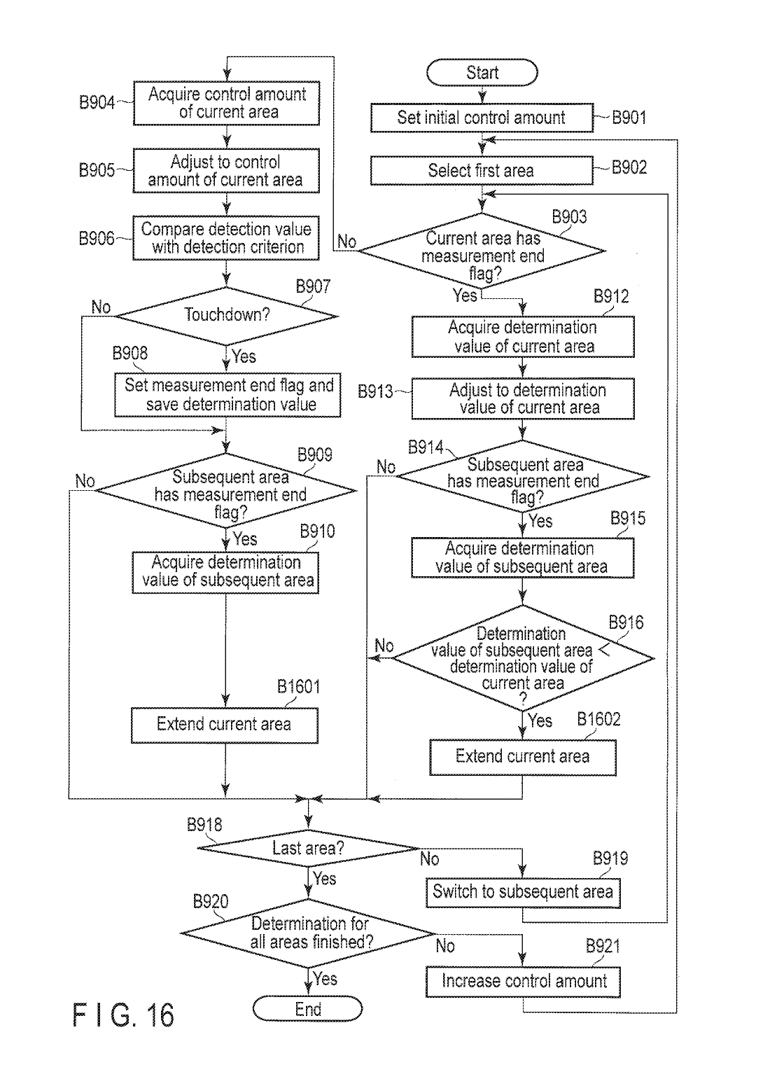

FIG. 16 is a flowchart showing a touchdown measuring method according to the second embodiment. The flowchart of FIG. 16 is substantially the same as the flowchart of FIG. 9. Therefore, processes similar to those of FIG. 9 are denoted by corresponding reference numbers, and no detailed description will be given thereof.

In B1601, the MPU 60 acquires the determination value of the subsequent area, extends the current area (reduces the subsequent area) by a range corresponding to a current response period, and proceeds to B918.

Further, if determined in B916 that the determination value of the subsequent area is lower than the determination value of the current area (YES in B916), in B1602, the MPU 60 acquires the determination value of the subsequent area, extends the current area (reduces the subsequent area) by a range corresponding to a current response period, and proceeds to B918.

Furthermore, if determining that all areas have been subjected to touchdown determination (YES in B920) after executing a plurality of processes, the MPU 60 finishes the touchdown measurement processing.

According to the embodiment, the magnetic disk device 1 adjusts a control amount in each of preset areas during touchdown measurement, and extends a current area when the determination value of a subsequent area is lower than the determination value of the current area. By thus controlling the control amount area by area, the head 15 can be prevented from excessively contacting the disk 10. As a result, failures, such as wear of the head 15 and a flaw of the disk 10, and other damage, can be suppressed. Moreover, since the magnetic disk 1 determines touchdown in an extended area, it can detect contact between the head and the disk in the extended area, which further suppresses excessive contact therebetween. As a result, failures, such as wear of the head 15 and a flaw of the disk 10, and other damage, can be further suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An adjustment method applied to read and write operations of a magnetic disk device comprising a disk, and a head including a heater and configured to protrude to the disk based on amount of heat of the heater varies in accordance with a control amount applied thereto, the adjustment method comprising:
calculating a first adjust amount by subtracting a difference, for spacing the head from the disk, from a first control amount applied to the heater when the head contacts a first area included in a plurality of areas into which a storage area of the disk is circumferentially divided;
calculating a second adjust amount by subtracting the difference from a second control amount applied to the heater when the head contacts a second area included in the plurality of areas, the second area being adjacent to the first area along a circumference of the disk; and
adjusting a time when the second adjust amount is applied to the heater, based on a result of comparison between the first and second control amounts.

2. The adjustment method of claim 1, wherein when the second control amount is smaller than the first control amount, the second control amount is applied to the heater earlier by a particular period than a time when a position of the head is switched to the second area.

3. The adjustment method of claim 1, wherein when the second control amount is greater than the first control amount, the second control amount is applied to the heater when a position of the head is switched to the second area.

4. The adjustment method of claim 2, further comprising:
calculating a third adjust amount by subtracting the difference from a third control amount applied when the head contacts a third area included in the plurality of areas and adjacent to the second area along the circumference of the disk;
comparing the second control amount with the third control amount; and
adjusting a time when the third adjust amount is applied to the heater, in accordance with a result of comparison between the second control amount and the third control amount.

5. The adjustment method of claim 4, wherein the particular period is a response period of the head needed until a current protrusion of the head shifts to a subsequent protrusion.

6. A magnetic disk device comprising:
a disk;
a head which includes a heater and configured to protrude to the disk based on amount of heat of the heater varies in accordance with a control amount applied thereto; and
a controller configured
to calculate a first adjust amount by subtracting a difference, for spacing the head from the disk, from a first control amount applied to the heater when the head contacts a first area included in a plurality of areas into which a storage area of the disk is circumferentially divided;
to calculate a second adjust amount by subtracting the difference from a second control amount applied to the heater when the head contacts a second area included in the plurality of areas, the second area being adjacent to the first area along a circumference of the disk; and
to adjust a time when the second adjust amount is applied to the heater, based on a result of comparison between the first and second control amounts.

7. The magnetic disk device of claim 6, wherein when the second control amount is smaller than the first control amount, the controller applies the second control amount to the heater earlier by a particular period than a time when a position of the head is switched to the second area.

8. The magnetic disk device of claim 6, wherein when the second control amount is greater than the first control amount, the controller applies the second control amount to the heater when a position of the head is switched to the second area.

9. The magnetic disk device of claim 7, wherein the controller is further configured to
calculate a third adjust amount by subtracting the difference from a third control amount applied when the head contacts a third area included in the plurality of areas and adjacent to the second area along the circumference of the disk;
compare the second control amount with the third control amount; and
adjust a time when the third adjust amount is applied to the heater, in accordance with a result of comparison between the second control amount and the third control amount.

10. The magnetic disk device of claim 9, wherein the particular period is a response period of the head needed until a current protrusion of the head shifts to a subsequent protrusion.

11. A method of manufacturing a magnetic disk device comprising a housing, a disk, and a head including a heater of which amount of heat varies in accordance with a control value applied thereto, the method comprising:
incorporating the disk into the housing;
applying a first control amount to the heater to protrude the head toward the disk by a first amount while the disk is rotated;
determining area by area whether the head contacts the disk, the disk being divided into a plurality of areas along circumference of the disk;
increasing the first control amount until it is determined that the head contacts one of the plurality of areas;
acquiring, as a second control amount, a first control amount when it is determined that the head contacts a first area of the plurality of areas; and
applying the second control amount to the heater while the head is positioned in the first area, applying a control amount greater than the second control amount while the head is positioned in an area other than the first area, and determining whether the head contacts the disk, when the head protrudes by a second amount greater than the first amount.

12. The method of claim 11, further comprising:
increasing the second control amount in non-contact areas which are included in the plurality of areas and are out of contact with the head, until it is determined that the head contacts one of the non-contact areas;
acquiring, as a third control amount, the second control amount when it is determined that the head contacts a second area included in the non-contact areas; and
applying the second control amount to the heater while the head is positioned in the first area, applying the third control amount to the heater while the head is positioned in the second area, applying a control amount greater than the third control amount to the heater while the head is positioned in an area other than the first and second areas, and determining that the head contacts the disk when the head protrudes by a third amount greater than the second amount.

13. The method of claim 12, further comprising:
increasing the third control amount in the non-contact areas until it is determined that the head contacts one of the non-contact areas;
acquiring, as a fourth control amount, a third control amount when it is determined that the head contacts a third area included in the non-contact areas; and
applying the second control amount to the heater while the head is positioned in the first area, applying the third control amount to the heater while the head is positioned in the second area, applying the fourth control amount to the heater while the head is positioned in the third area, applying a control amount greater than the fourth control amount to the heater while the head is positioned in an area other than the first, second and third areas, and determining that the head contacts the disk when the head protrudes by a fourth amount greater than the third amount.

14. The method of claim 13, further comprising:
increasing a control amount in the non-contact areas until it is determined that the head contacts a one of the non-contact areas;
acquiring, as a current control amount, a control amount when it is determined that the head contacts a current area that is included in the non-contact areas and includes a position where the head is currently positioned; and
applying a respective control amount to the heater when the head is positioned in a respective area, applying a control amount greater than the current control amount to the heater while the head is positioned in any of the non-contact areas, determining that the head contacts the disk when the head protrudes by an amount greater than a current protrusion, and repeating the determining until it is determined that the head contacts the disk in all of the non-contact areas.

15. The method of claim 14, wherein when it is determined, in a subsequent area included in the plurality of areas and adjacent to the current area along the circumference of the disk, whether the head contacts the disk by a subsequent control amount smaller than the current control amount, applying the subsequent control amount to the heater earlier by a particular period than a time when the head reaches the subsequent area.

16. The method of claim 15, wherein the particular period is a response period of the head needed until a current protrusion of the head shifts to a subsequent protrusion.

17. The method of claim 14, wherein when it is determined that the head contact the disk by a control amount smaller than the current control amount in the subsequent area adjacent to the current area along the circumference of the disk, the subsequent area is extended by a particular range, and the current area is reduced by the particular range.

18. The method of claim 17, wherein the particular range is a range corresponds to a response period of the head needed until a current protrusion of the head shifts to a subsequent protrusion.

19. The method of claim 14, further comprising:
radially dividing the disk into a plurality of radial zones;
providing a plurality of sectors where each of the plurality of zones is divided into the plurality of areas;
selecting a first zone from the plurality of zones;
selecting a first section from the first zone;
selecting at least one of a plurality of first radial recording areas included in the first section;
averaging a fifth control amount applied to the heater when it is determined that the head contacts the disk in the selected first radial recording area, thereby calculating a first average;
calculating a first adjust amount by subtracting, from the first average, a difference for spacing the head from the disk;
selecting a second section radially separate from the first section;
selecting at least one of a plurality of second radial recording areas included in the second section;
averaging a sixth control amount applied to the heater when it is determined that the head contacts the disk in the selected second radial recording area, thereby calculating a second average; and
calculating a second adjust amount by subtracting the difference from the second average.

20. The method of claim 19, further interpolating an adjust amount for at least one section provided between the first and second sections, using the first and second adjust amounts.
